(19) United States
(12) Patent Application Publication
(10) Pub. No.: US 2025/0113255 A1
(43) Pub. Date: Apr. 3, 2025

(54) Semantic Communication

(71) Applicant: Apple Inc., Cupertino, CA (US)

(72) Inventors: Danila ZAEV, Munich (DE); Ahmed M SOLIMAN, Munich (DE); Ayman F NAGUIB, Cupertino, CA (US); Kenza HAMIDOUCHE, Cupertino, CA (US); Sabine ROESSEL, Munich (DE)

(21) Appl. No.: 18/883,676

(22) Filed: Sep. 12, 2024

Related U.S. Application Data
(60) Provisional application No. 63/586,528, filed on Sep. 29, 2023.

(51) Int. Cl. H04W 28/18; H04L 5/00

(52) U.S. Cl. CPC H04W 28/18; H04L 5/0053; H04L 5/0067

(57) ABSTRACT

An apparatus configured to receive data inputs corresponding to a plurality of data objects that are to be transmitted, process the data inputs to generate a semantic representation of each of the data objects, wherein the semantic representation comprises a semantic distance for each of the data objects, wherein the semantic distance relates each of the data objects to each other and prepare, for transmission, the semantic representations of the data objects.

### PRIORITY/INCORPORATION BY REFERENCE

This application claims priority to U.S. Provisional Application Ser. No. 63/586,528 filed on Sep. 29, 2023, entitled “Semantic Communication,” the entirety of which is incorporated by reference herein.

### BACKGROUND

Wireless communication systems are rapidly growing in usage and constantly evolving. Users expect a high quality experience on wireless networks including when executing real-time applications with heavy traffic such as virtual reality (VR)/augmented reality (AR) applications including holographic conferencing, ultra-high-resolution video-on-demand, video conferencing under bad channel conditions, cloud gaming, etc. Traditional communication modes that use error-free deterministic communication have heavy computational demands and high processing delays. These traditional communication modes may not be equipped to dela with the demands of users in the future.

### SUMMARY

Some example embodiments are related to an apparatus having processing circuitry configured to receive data inputs corresponding to a plurality of data objects that are to be transmitted, process the data inputs to generate a semantic representation of each of the data objects, wherein the semantic representation comprises a semantic distance for each of the data objects, wherein the semantic distance relates each of the data objects to each other and prepare, for transmission, the semantic representations of the data objects.

Other example embodiments are related to an apparatus having processing circuitry configured to jointly train a variational autoencoder (VAE) and a VAE decoder based on a training data set comprising data related to semantic distance, add a scaling layer to the VAE to generate a semantic processing model, eliminate noise dimensions from the VAE and train a semantic processing reconstruction model based on the training data set, the semantic processing model and data generated from eliminating the noise dimensions.

Still further example embodiments are related to an apparatus having processing circuitry configured to receive a data input corresponding a data object to be transmitted, process the data input to generate a semantic representation of the data object, generate an Internet Protocol (IP) packet comprising the semantic representation and a header indicating a data type of the semantic representation and generate a transport block (TB) comprising a soft delivery part and an exact delivery part, wherein the soft delivery part comprises the semantic representation of the data object.

### BRIEF DESCRIPTION OF THE DRAWINGS

FIG. 1 shows an example network arrangement according to various example embodiments.

FIG. 2 shows an example user equipment (UE) according to various example embodiments.

FIG. 3 shows an example base station according to various example embodiments.

FIG. 4 shows an example system architecture for semantic communication according to various example embodiments.

FIG. 5 shows an example flow for a semantic processing neural network (NN) or a semantic restoration NN using an application specific integrated circuit (ASIC) according to various example embodiments.

FIG. 6 shows an overview of an example training procedure for the semantic processing NN and semantic restoration NN according to various example embodiments.

FIG. 7 shows an example parametric model for a Beta-variational autoencoder (β-VAE) training according to various example embodiments.

FIG. 8 shows an example of data vectors of semantic representations at a Medium Access Control (MAC) layer of a transmitter according to various example embodiments.

FIG. 9 shows an example Internet Protocol (IP)/transport level protocol packet for soft communications according to various example embodiments.

FIG. 10 shows an example of a Radio Link Control (PLC) Protocol Data Unit (PDU) comprising a MAC PDU used for soft communications according to various example embodiments.

FIG. 11 shows an example soft delivery part of a transport block (TB) for soft communications according to various example embodiments.

### DETAILED DESCRIPTION

The example embodiments may be further understood with reference to the following description and the related appended drawings, wherein like elements are provided with the same reference numerals. The example embodiments relate to a semantic communication system that includes functionality extensions for an application layer, layer 2 and layer 3 and the physical (PHY) layer for both a transmitter and a receiver.

The example embodiments are described with regard to a user equipment (UE). However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate type of electronic component.

The example embodiments are also described with regard to a sixth generation (6G) network. However, reference to a 6G network is merely provided for illustrative purposes. The example embodiments may be utilized with any appropriate type of network and that supports semantic communications as described herein, including future evolutions of the cellular standards beyond 6G.

The example embodiments are related to semantic communications. Semantic communications differ from traditional or classic communications. Specifically, traditional communication modes use error-free deterministic communications, e.g., the data that is to be transmitted by a transmitter and received by a receiver is the actual data that is to be exchanged, e.g., data that represents pixel values of an image. In contrast, semantic communications are not limited to transmission of the actual data. Rather, semantic communications transmit semantic representations of the data, e.g., semantic data or metadata about the data that is to be transmitted. The receiver may use this semantic data or metadata to reconstruct the actual data that the transmitter intends without the transmitter sending the actual data.

One advantage of semantic communications is that the semantic representations of data, e.g., semantic data or metadata about the data to be transmitted, may be smaller than the actual data to be transmitted. To provide an example, the semantic representation of an image may be significantly smaller than the actual data of the image. This reduction in the amount of data required to exchange information between a transmitter and receiver may allow for higher throughputs to accommodate heavy traffic scenarios.

Semantic communications is not data compression. That is, traditional communication modes may use various compression algorithms to compress the size of the actual data, e.g., there are multiple forms of MPEG compression that reduce the size of video files for traditional communications. These forms of compression typically remove some of the actual data from the data being transmitted and the receiver may decode the compressed data using interpolation or other methods. Semantic communications are different from compression (or encoding) because the reduced amount of data used for semantic communications is not a subset of the actual data as in traditional communication compression.

To provide a very simple example of transmitting an image that includes a tree. Traditional communication modes need to represent each pixel of the image that includes the tree and transmit those representations of each pixel to the receiver. The receiver may decode the representations of each pixel and display the image. In contrast, in semantic communications, the semantic representation may be as simple as indicating a ‘tree.’ The receiver may then place a tree in the image. The semantic representation may be more complicated, e.g., ‘a tree with green leaves’, ‘a tree with fall color leaves’, ‘an oak tree’, etc. From this simple example, it can be seen that the amount of data used to convey the same information is significantly less using semantic communications.

However, because the semantic representation is not the actual data, there may be errors introduced by the semantic communications. The example embodiments use various techniques to ensure that the semantic representations of the data convey the meaning of the data from the transmitter to the receiver.

Throughout this description, there are different terms used to describe semantic data. The term semantic representation is used above and describes the data or metadata representing the actual data, e.g., information that provides the meaning of the actual data. In some cases, this semantic representation is represented as data vectors, e.g., the input data is a data vector of the actual data and is processed to result in the semantic representation.

Data may also be described as belonging to a specific data category. A data category may be considered the kind of data that is treated by an application in a specific manner. Examples are video frames, audio frames, text, 3-D video, sensing cubes, etc. As will be described in more detail below, an application layer of the transmitter and receiver may have specific models for handling each data category.

There may also be different data types, which may be considered to be numerical data that are typically used in number representation in digital systems. For example, an unsigned 8-bit integer is a typical example of a data type. Thus, data categories may be represented by one or more data types.

The example embodiments describe an application layer functionality extension for semantic communications. These functionality extension may include, but are not limited to, semantic distance definition, structure and implementation of semantic processing and a semantic reconstruction neural network models, including a training procedure for the isometric semantic processing and semantic reconstruction models, motion compensation in the context of the semantic communications and data statistics gathering.

The example embodiments also describe Medium Access Control (MAC) layer extensions for semantic communications. These functionality extension may include, but are not limited to, rate matching and modulation selection, Downlink Control Information (DCI) extension including modulation scheme indices, data vector indices, and an end-of-data flag, a soft control data structure including a soft integrity check, new MAC scheduler functionality, and adjustment of PHY parameters.

The example embodiments also describe PHY layer extensions for semantic communications. These functionality extension may include, but are not limited to, superposition for latent feature multiplexing by the PHY layer and softly coded PHY transmissions.

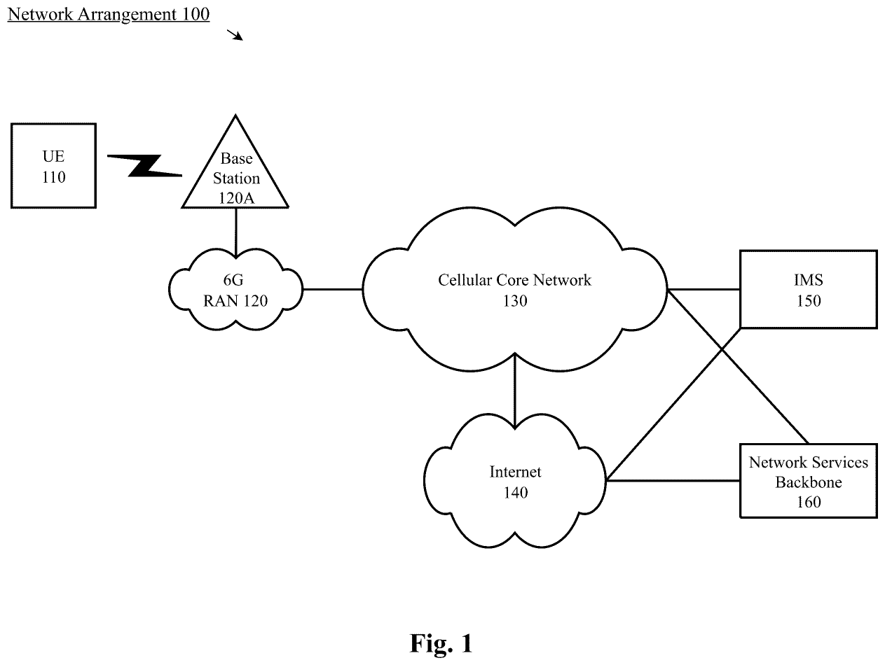

FIG. 1 shows an example network arrangement 100 according to various example embodiments. The example network arrangement 100 includes a UE 110. The UE 110 may be any type of electronic component that is configured to communicate via a network, e.g., mobile phones, tablet computers, desktop computers, smartphones, phablets, embedded devices, wearables, Internet of Things (IoT) devices, etc. An actual network arrangement may include any number of UEs being used by any number of users. Thus, the example of a single UE 110 is merely provided for illustrative purposes.

The UE 110 may be configured to communicate with one or more networks. In the example of the network configuration 100, the network with which the UE 110 may wirelessly communicate is a 6G radio access network (RAN) 120. However, the UE 110 may also communicate with other types of networks (e.g., fifth generation (5G) RAN, 5G cloud RAN, a next generation RAN (NG-RAN), a long-term evolution (LTE) RAN, a legacy cellular network, a wireless local area network (WLAN), etc.) and the UE 110 may also communicate with networks over a wired connection. With regard to the example embodiments, the UE 110 may establish a connection with the 6G RAN 120. Therefore, the UE 110 may have at least a 6G chipset to communicate with the 6G RAN 120.

The 6G RAN 120 may be a portion of a cellular network that may be deployed by a network carrier (e.g., Verizon, AT&T, T-Mobile, etc.). The 6G RAN 120 may include base stations or access nodes (Node Bs, eNodeBs, HeNBs, eNBS, gNBs, gNodeBs, macrocells, microcells, small cells, femtocells, etc.) that are configured to send and receive traffic from UEs that are equipped with the appropriate cellular chip set.

Any association procedure may be performed for the UE 110 to connect to the 6G RAN 120. For example, as discussed above, the 6G RAN 120 may be associated with a particular cellular provider where the UE 110 and/or the user thereof has a contract and credential information (e.g., stored on a SIM card). Upon detecting the presence of the 6G RAN 120, the UE 110 may transmit the corresponding credential information to associate with the 6G RAN 120. More specifically, the UE 110 may associate with a specific base station, e.g., the gNB 120A.

The network arrangement 100 also includes a cellular core network 130, the Internet 140, an IP Multimedia Subsystem (IMS) 150, and a network services backbone 160. The cellular core network 130 may refer to an interconnected set of components that manages the operation and traffic of the cellular network. It may include the evolved packet core (EPC), the 5G core (5GC), the 6G core (6GC). The cellular core network 130 also manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

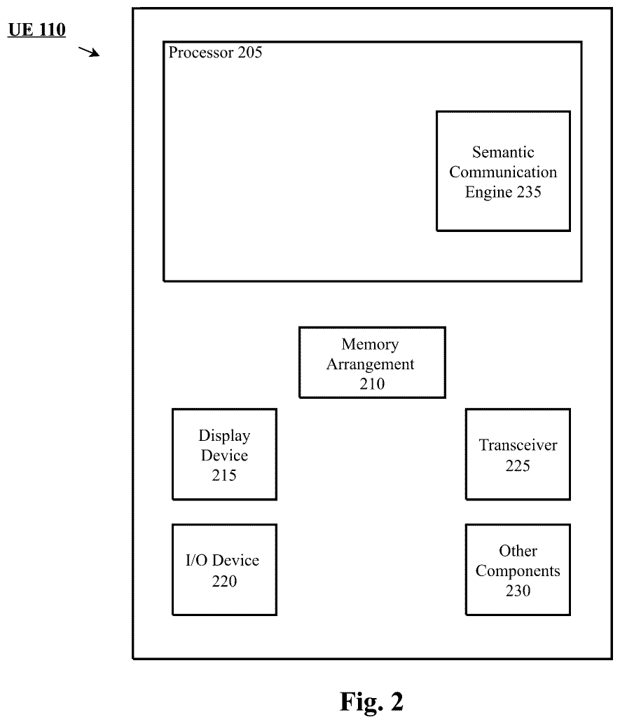

FIG. 2 shows an example UE 110 according to various example embodiments. The UE 110 will be described with regard to the network arrangement 100 of FIG. 1. The UE 110 may include a processor 205, a memory arrangement 210, a display device 215, an input/output (I/O) device 220, a transceiver 225 and other components 230. The other components 230 may include, for example, an audio input device, an audio output device, a power supply, a data acquisition device, ports to electrically connect the UE 110 to other electronic devices, etc.

The processor 205 may be configured to execute a plurality of engines of the UE 110. For example, the engines may include a semantic communication engine 235. The semantic communication engine 235 may perform various operations such as, but not limited to, semantically encoding data, rate matching semantic data for transmission, applying PHY layer parameters for semantic transmissions, and decoding semantic data to reconstruct the original input data. Each of these example operations will be described in greater detail below.

The above referenced engine 235 being an application (e.g., a program) executed by the processor 205 are merely provided for illustrative purposes. The functionality associated with the engine 235 may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engine may also be embodied as one application or separate applications. In addition, in some UEs, the functionality described for the processor 205 is split among two or more processors such as a baseband processor and an applications processor. In particular, in some examples, it is the capabilities of the UE 110 typically handled by the baseband processor that may be reduced when the UE 110 is operating in the low battery mode. The example embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen.

The transceiver 225 may be a hardware component configured to establish a connection with the 6G-RAN 120, an LTE-RAN (not pictured), a legacy RAN (not pictured), a WLAN (not pictured), etc. Accordingly, the transceiver 225 may operate on a variety of different frequencies or channels (e.g., set of consecutive frequencies). The transceiver 225 includes circuitry configured to transmit and/or receive signals (e.g., control signals, data signals). Such signals may be encoded with information implementing any one of the methods described herein. The processor 205 may be operably coupled to the transceiver 225 and configured to receive from and/or transmit signals to the transceiver 225. The processor 205 may be configured to encode and/or decode signals (e.g., signaling from a base station of a network) for implementing any one of the methods described herein.

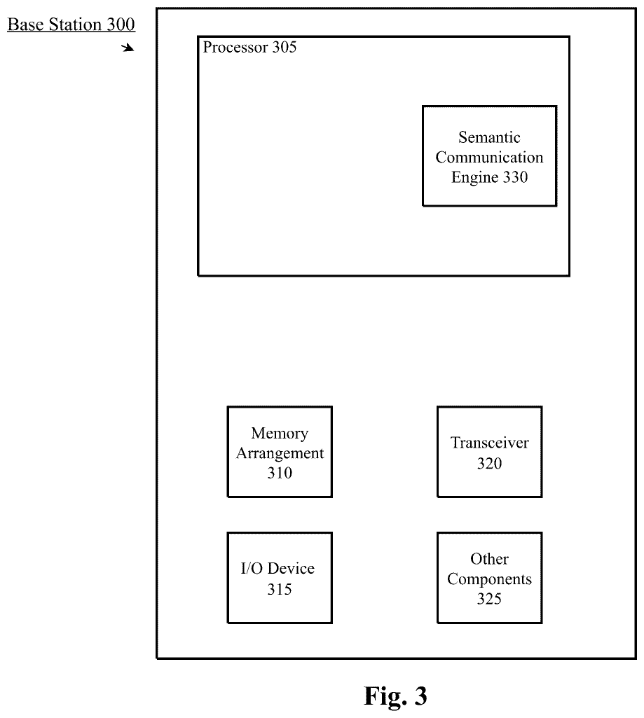

FIG. 3 shows an example base station 300 according to various example embodiments. The base station 300 may represent any base included within the network, e.g., base station 120A.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, TxRUs, transceiver chains, antenna elements, antenna panels, etc.

The processor 305 may be configured to execute a plurality of engines for the base station 300. For example, the engines may include a semantic communication engine 330. The semantic communication engine 330 may perform various operations for the base station 300 related to semantic communications.

The above noted engine 330 being an application (e.g., a program) executed by the processor 305 is only an example. The functionality associated with the engine 330 may also be represented as a separate incorporated component of the base station 300 or may be a modular component coupled to the base station 300, e.g., an integrated circuit with or without firmware. For example, the integrated circuit may include input circuitry to receive signals and processing circuitry to process the signals and other information. In addition, in some servers, the functionality described for the processor 305 is split among a plurality of processors (e.g., a baseband processor, an applications processor, etc.). In particular, in some examples, it is the operations for communicating with the UE 110 that are typically handled by the baseband processor that may be reduced when the UE 110 is operating in the low battery mode. The example embodiments may be implemented in any of these or other configurations of a server.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UEs in the network arrangement 100.

The transceiver 320 may operate on a variety of different frequencies or channels (e.g., set of consecutive frequencies). Therefore, the transceiver 320 may include one or more components to enable the data exchange with the various networks and UEs. The transceiver 320 includes circuitry configured to transmit and/or receive signals (e.g., control signals, data signals). Such signals may be encoded with information implementing any one of the methods described herein. The processor 305 may be operably coupled to the transceiver 320 and configured to receive from and/or transmit signals to the transceiver 320. The processor 305 may be configured to encode and/or decode signals (e.g., signaling from a UE) for implementing any one of the methods described herein.

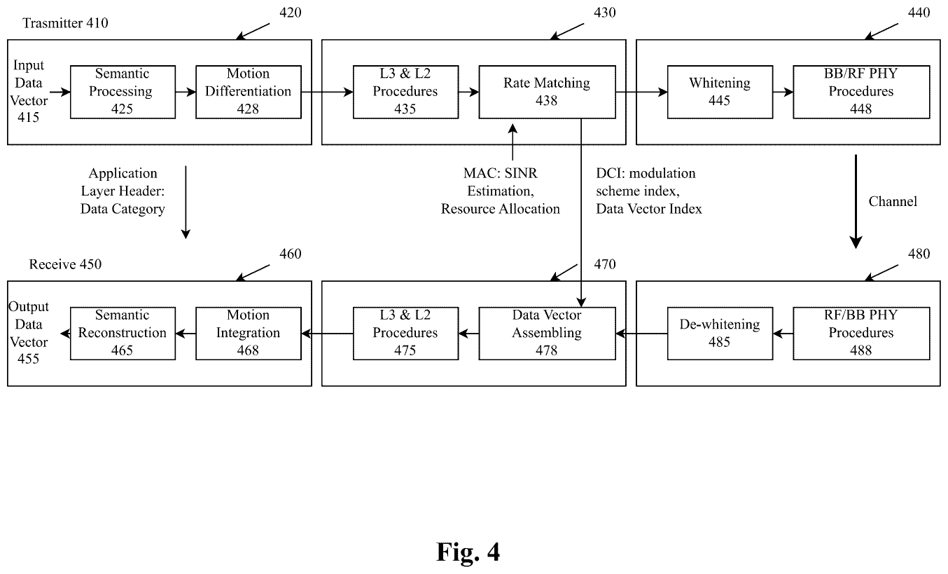

FIG. 4 shows an example system architecture 400 for semantic communication according to various example embodiments. The system architecture 400 shows a transmitter 410 and a receiver 450. The transmitter 410 may be the device that is transmitting the data using semantic communication while the receiver 450 may be the device that is receiving the data via semantic communication and reconstructing the data. In the example of FIG. 4, it may be considered that the transmitter 410 and the receiver 450 are UEs (e.g., UE 110) but there is no requirement that both the transmitter 410 and the receiver 450 be UEs. It may be possible that one of the transmitter 410 and receiver 450 are different types of devices such as a network server or other component in communication with a UE, e.g., a streaming service server that is streaming content to a UE.

The system architecture 400 shows multiple communication layers for each of the transmitter 410 and the receiver 450, including an application layer, layer 2 (L2) and layer 3 (L3) and a physical (PHY) layer. These are shown as application layer 420, L2 and L3 layers 430 and PHY layer 440 for the transmitter 410 and application layer 460, L2 and L3 layers 470 and PHY layer 480 for the receiver 450. Various procedures for semantic communication may be performed in each of these communication layers at both the transmitter 410 and receiver 450. These procedures will be described in greater detail below. However, the transmitter 410 and receiver 450 are not required to perform each of these procedures for all semantic communications, e.g., different types of data or different data categories may use different semantic communication procedures.

Prior to describing the specific procedures implemented at the various layers of the transmitter 410 and receiver 450, a general overview of the semantic communication will be described with reference to the system architecture 400. The transmitter 410 may have input data 415 that is to be transmitted to the receiver 450. The input data 415 is subjected to sematic processing 425 at the application layer 420 that may involve processing the input data 415 using an artificial intelligence (AI)/machine learning (ML) model. Examples of training an AI/ML model for semantic processing will be described in greater detail below. The semantically processed input data may then be processed for motion differentiation 428 at the application layer 420. As described above, the motion differentiation processing 428 may apply to only certain data types or data categories.

The input data is then passed to the L2 and L3 layers 430 for L2 and L3 procedures 435 to be performed on the input data. The L2 and L3 layers 430 may also perform rate matching 438 on the input data. The input data is then passed to the PHY layer 440 for whitening 445, which again may be applicable to only certain data types or data categories. Finally, the input data is subjected to baseband (BB) and radio frequency (RF) procedures 448 at the PHY layer 440 for transmission to the receiver 450 via a channel.

The data received at the receiver 450 is then processed to reconstruct the input data at the receiver 450. This reconstruction includes BB and RF procedures 488 and de-whitening 485 at the PHY layer 480 of the receiver 450. Data vector assembling 478 and L2 and L3 procedures 475 at the L2 and L3 layers 470 of the receiver 450. Motion integration 468 and semantic reconstruction 465 at the application layer 460 of the receiver 450 to generate the output data 455. Similar to the semantic processing 425 of the transmitter 410, the semantic reconstruction 465 may include the use of AI/ML models for reconstruction purposes. Thus, at the conclusion of the described process, the receiver 450 should have reconstructed the input data 415 as output data 455.

Turning to the specific operations at each of the layers of the transmitter 410 and the receiver 450. Initially, the operations at the corresponding application layers 420 and 450 will be described. When semantically processing 425 or semantically reconstructing 465 the data, a semantic distance (Dₛₑₘ) may be defined in a specific manner for each category of data, e.g., Dₛₑₘ: X×X→ [symbol] _{≥0}.

The semantic distance definition captures the perceptual difference between data objects. For example, data may be represented as a point in an N-dimensional vector space X= [symbol] ^{N}, which is called ‘observation space’ or ‘input space’. The vector space [symbol] ^{N} may be defined over any field (e.g., [symbol] or {0, 1}).

In some example embodiments, the semantic distance may be defined as a geodesic distance. For example, the ground truth data distribution be concentrated at (supported by) a manifold [symbol] ⊆ [symbol] ^{N}. In this case, semantic distance may be defined as a geodesic distance at the data manifold [symbol] ⊆ [symbol] ^{N}, which may then be extended to the space X= [symbol] ^{N} as follows:
(p) [symbol] :=arg_{pk∈Dataset}min h(∥p−pₖ∥²), where h(⋅): [symbol] → [symbol] is a monotonically non-increasing function.

### Thus,

$${D}_{seem} ( p , {p}^{′} ) := h ( {‖ p - ( p ) ‖}^{2} ) + h ( {‖ {p}^{′} - ( {p}^{′} ) ‖}^{2} ) + GeoDist ( ( p ) , ( {p}^{′} ) )$$

In other example embodiments, the semantic distance (Dₛₑₘ) may be a domain knowledge defined distance. For example, for some categories of data, the perception-based distance may be defined using the domain knowledge. To provide a specific example, structured similarity (SSIM) for images.

Thus, two neural network (NN) models may be defined for each data category a semantic processing 425 NN model for the transmitter 410 and a semantic restoration 465 NN model for the receiver 450. The semantic processing 425 NN and the semantic restoration 465 NN may be pre-trained NN models that are shared with the transmitter 410 and the receiver 450. Example manners of training the semantic processing 425 NN and the semantic restoration 465 NN are described below.

The semantic processing 425 NN and the semantic restoration 465 NN may map the semantic distance (Dₛₑₘ) in the input space into Euclidian distance in the output space (also called latent space):

$${D ( {x}_{1} , {x}_{2} )}_{sem} = {‖ f ( {x}_{1} ) - f ( {x}_{2} ) ‖}_{2} := {( {\sum }_{m - 1}^{M} {\vert {f ( {x}_{1} )}_{m} - {f ( {x}_{2} )}_{k} \vert}^{2} )}^{1 / 2}$$

In some example embodiments, the transmitter and/or receiver may implement the semantic processing 425 NN and the semantic restoration 465 NN using an application specific integrated circuit (ASIC) or using acceleration with the help of co-processors. In these example embodiments, a same ASIC model may be used for multiple data categories with category specific weights, which are pre-trained for a specific category.

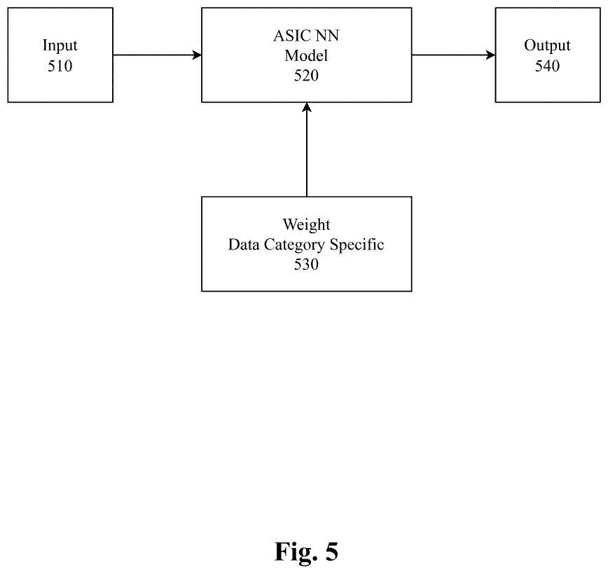

FIG. 5 shows an example flow for a semantic processing 425 NN or a semantic restoration 465 NN using an application specific integrated circuit (ASIC) according to various example embodiments. The input 510 may be, for example, an N-dimensional vector. As described above, the ASIC NN model 520 may have weight data that is data category specific such that the same ASIC NN model 520 may be used for multiple data categories. The output 540 may be the M-dimensional vector of high-precision values (e.g., fixed point real values represented by 2^{b} bits).

In some example embodiments, the semantic processing 425 NN and the semantic restoration 465 NN may be a diagonal-circulant neural network type. This form of neural network may allow low-complexity implementation since multiplication by diagonal or circulant matrix takes O(N) or O(N log N) operations, respectively.

A NN, f: [symbol] ^{N}→ [symbol] ^{M} may be considered a diagonal-circulant neural network if and only if

$$f ( x ) := {f}_{DL , CL , bL} ∘ {f}_{DL , CL , bL} ∘ … ∘ {f}_{D 1 , C 1 , b 1} \qquad ( x )$$

f_{Di,Ci,bi}:=φᵢ (DᵢCᵢx+bᵢ), where:
Dᵢ is a diagonal matrix,
Cᵢ is a circulant matrix, bᵢ is a vector, and
φᵢ is a rectified linear unit (ReLU) or identity function.

In other example embodiments, the semantic processing 425 NN and the semantic restoration 465 NN may be a composition of several layers of specific pre-defined structure, followed by a diagonal-circulant neural network, then followed by several layers of specific pre-defined structure. This flexible structure allows to incorporate such processing procedures as discrete cosine transform (DCT), image slicing, non-linear scaling, etc., which may be used some data categories.

The isometric property of the models implemented in the above example embodiments means that the Euclidian distortion (also known as Mean Squared Error (MSE) distortion) of the encoded data is equal to the semantic distortion of the row data after decoding, up to some global coefficient. If this is the case, the minimization of the Euclidian (MSE) distortion by the communication system directly leads to a minimization of the semantic distortion of the decoded data at the receiver. Thus, the training and use of isometric autoencoder model for arbitrary data categories results in a minimal amount of semantic distortion.

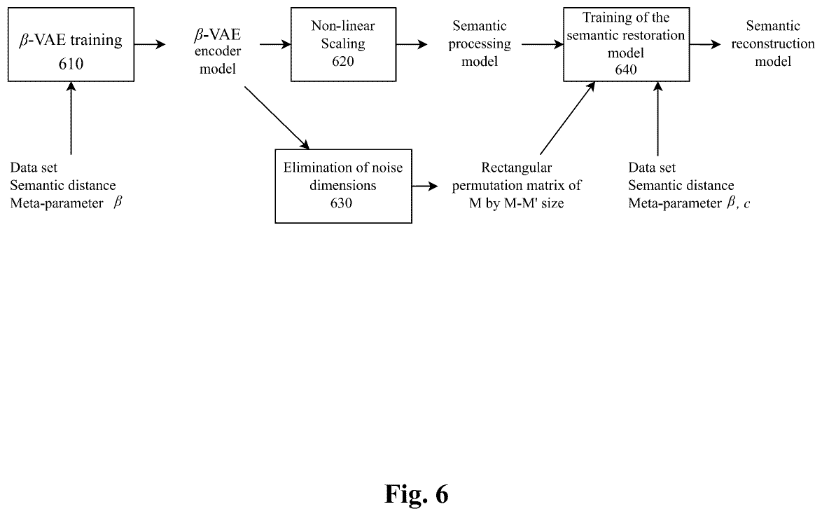

FIG. 6 shows an overview of an example training procedure for the semantic processing 425 NN and semantic restoration 465 NN according to various example embodiments. The training procedure described with reference to FIG. 6 is only one example of a training procedure and other training procedures may be used to train the semantic processing 425 NN and semantic restoration 465 NN.

In 610, a Beta-variational autoencoder (β-VAE) is trained using a training data set for semantic distance including a meta-parameter β. In this training 610, the β-VAE encoder and the β-VAE decoder are jointly trained but only the β-VAE encoder is retained.

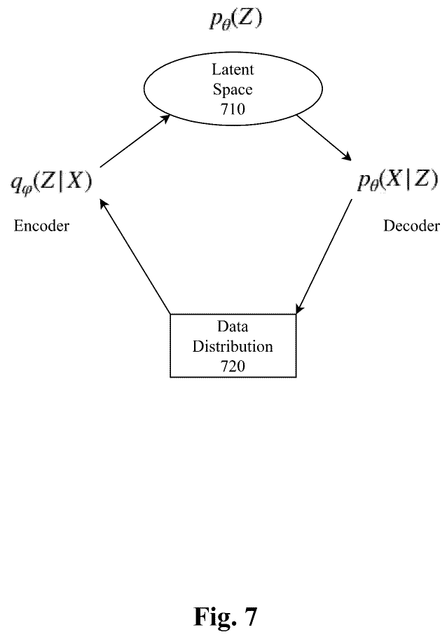

FIG. 7 shows an example parametric model for the Beta-variational autoencoder (β-VAE) training according to various example embodiments. As shown in FIG. 7, the parametric model Pθ(z) of the latent space 710 may be derived from the data distribution 720 where q_{ϕ}(Z|X)≅p_{θ}(x|Z) for the encoder and decoder, respectively. Typical choices of prior and posterior distributions may be as follows:
p_{θ}(Z)˜ [symbol] (z; 0, I_{M}), i.e., the latent space 710 variable is a standard Gaussian distribution; and
q_{ϕ}(Z|X)˜ [symbol] (z; μ(x; ϕ), σ(x; ϕ)), i.e., the encoder maps a data point into a Gaussian distribution on latent space 710 with a non-trivial mean and variation.

If it is considered that β is a fixed regularization parameter, an optimization target in β-VAE training may be an evidenced lower bound (ELBO) as follows:

$$ℒ ( ϕ , θ ) := {E}_{p ( X )} ( {E}_{q ϕ ( Z \vert X )} ( log {p}_{θ} ( x \vert z ) ) - β \cdot {D}_{K L} ( {q}_{ϕ} ( Z \vert X ) ‖ p ( Z ) ) )$$

[symbol] (ϕ, θ)→max_{ϕθ} where ELBO is optimized with gradient-based back propagation methods.

Under these assumptions,

$${D}_{KL} ( {q}_{ϕ} ( Z \vert X ) ‖ p ( Z ) ) = {\sum }_{m = 1}^{M} ( {μ}_{m}^{2} ( x ; ϕ ) + {σ}_{m}^{2} ( x ; ϕ ) - 2 log {σ}_{m} ( x ; ϕ ) - 1 )$$

Eₚ₍ₓ₎(E_{qϕ}(Z|X)(log p_{θ}(x|z))≅Eₚ₍ₓ₎(Dₛₑₘ(x, x_{ϕθ}) where x_{ϕθ} is the output of encoding sampling and then decoding of x is:

$$ℒ ( ϕ , θ ) ≃ {E}_{p ( X )} ( {D}_{sem} ( x , {x}_{ϕθ} + {\sum }_{m = 1}^{M} ( {μ}_{m}^{2} ( x ; ϕ ) + {σ}_{m}^{2} ( x ; ϕ ) - 2 log {σ}_{m} ( x ; ϕ ) - 1 ) \to {min}_{ϕθ}$$

Returning to FIG. 6, after the β-VAE training 610, there is β-VAE encoder model. This β-VAE encoder model may be input to the non-linear scaling module 620 to add a scaling layer to the trained β-VAE encoder. This extended encoder may be considered to be the semantic processing model.

The following provides additional details on the operations performed by the scaling module 620. The β-VAE encoder model is not isometric, e.g., the geodesic distance does not map into Euclidian distance. That is, after the β-VAE encoder model is trained, the following encoder map is. obtained:
f: [symbol] N→ [symbol] ^{2M}
f(x):=(μ(x; ϕ^{opt}), σ(x; ϕ^{opt})), where both μ(x; ϕ^{opt}) and σ(x; ϕ^{opt}) are M-dimensional vectors.

To obtain an isometric representation in the latent space 710, the following transform (non-linear scaling) may be applied:

$${y}_{m} := \sqrt{β} \frac{1}{{σ}_{x}^{m}} {μ}_{x}^{m} for each m = 1 , … . , M$$

Thus, the isometric semantic processing map may be defined as:

$${f ( x )}_{m}^{iso} := \sqrt{β} \frac{{f ( x )}_{m}}{{f ( x )}_{m + M}} - E ( {Y}_{m} ) for each m = 1 , … . , M$$

The normalized semantic processing map may be defined as:

$${f ( x )}_{m}^{norm} := \sqrt{β} {Var}^{\frac{- 1}{4}} ( {Y}_{m} ) \frac{{f ( x )}_{m}}{{f ( x )}_{m + M}} - E ( {Y}_{m} ) for each m = 1 , … . , M$$

In some example embodiments, a power control transform may also be applied to the optimal Gaussian source transmission as follows:

$${Y}_{m}^{norm} := \frac{1}{{Var}^{\frac{1}{4}} {Y}_{m}} {y}_{m} - E ( {Y}_{m} ) , for each m = 1 , … . , M$$

When a data category is not provided to the communication system, the power control scaling should be performed at the application layer and the normalized semantic processing map is used as a semantic processing map, e.g., f:=f^{norm}.

On the other hand, when the communication system is informed about the data category, power scaling may be skipped at the application layer, and may be performed at the MAC and or PHY layers. In this case, data statistics may be provided to those communication layers and the isometric map is used as the semantic processing map, e.g., f:=f^{iso}.

Once again, returning FIG. 6, after the β-VAE training 610, there is β-VAE encoder model. This β-VAE encoder model may also be input to noise dimension elimination module 630. In this example, M′ dimensions (out of M) are eliminated, and the value M-M′ is provided to the lower layers of the system.

The following provides additional details on the operations performed by the noise dimension elimination module 630. For example, let X comprise a random variable corresponding to the “ground truth” distribution of the input data set. X\hat{ } is encoded, sampled and then decoded: X\hat{ }:=f⁻¹(f(X)+ε). Y comprises a random variable corresponding to the semantic representation of the X, i.e., Y:=f(X), while Ŷ is defined as a sampled object in the representation space (i.e., Ŷ:=f(X)+ε).

The isometric property between the original data space and the latent representation space implies the following equality:

$$\begin{matrix}I ( X ; \hat{X} ) = I ( Y ; \hat{Y} ) = H ( Y ) - H ( ( 0 ; β \cdot {I}_{M} ) ) = H ( Y ) - \frac{M}{2} log ( 2 βπ e ) \\ = {{\sum }^{M}}_{m = 1} ( H ( {y}_{m} ) - \frac{1}{2} log ( 2 βπ e ) )\end{matrix}$$

Thus, after the semantic processing, the entropy H(yₘ) of each dimension m=1, . . . , M of the representation vector may be estimated based on the data set and compared to the

$$\frac{1}{2} log ( 2 βπ e ) \cdot$$

The dimensions may then be ordered in decreasing order based on the estimated entropy. Any dimensions that have entropy less than

$$\frac{1}{2} log ( 2 βπ e )$$

may be eliminated. These operations may be performed by multiplying representation vector y by a rectangular M by M-M′ permutation matrix, which may be denoted by P.

Returning FIG. 6 one more time, the final operation is the training of the semantic restoration model 640. As shown in FIG. 6, the inputs in this training may include the semantic processing model output from the non-linear scaling module 620, the rectangular M by M-M′ permutation matrix output by the noise dimension elimination module 630 and a training data set for semantic distance including a meta-parameters 3, c. The meta-parameter c may depend on the meta-parameter R but that is not a requirement. Training of the semantic restoration model may provide a tradeoff between reconstruction accuracy and robustness.

After the semantic processing model f is trained, the second model, the semantic reconstruction model, may be trained to approximate the inverse map (f)⁻¹. Since the system will transmit the semantic representation y through a non-deterministic channel, allowing distortions, the reconstruction model should have a certain robustness to account for the distortions.

The reconstruction model may be trained to minimize the following function:

$$ℒ ( θ ) ≃ {𝔼}_{p ( X )} ( {D}_{sem} ( x , {\hat{x}}_{θ} ) + c \cdot {D}_{sem} ( {\hat{x}}_{θ} , {\hat{x}}_{θ} ) ) \to {min}_{θ}$$

The first summand listed below corresponds to accuracy of reconstruction, while the second summand listed below is related to the robustness and generalization capability.

$$\begin{matrix}{\hat{x}}_{θ} := {g}_{θ} ( P \cdot f ( x ) ) \\ {\tilde{x}}_{θ} := {g}_{θ} ( P \cdot f ( x ) + ε ) , where \\ ε \sim ( 0 ; β \cdot {Var}^{- 1} ( y ) \cdot {I}_{M - M} ,\end{matrix}$$

because noise is generated as a normal variable with variance corresponding to the theoretical variance of a semantic representation conditioned on the corresponding input vector.

While not shown in FIG. 6, the training procedure may further include a quality control loop to check the final quality of the trained system of models from both an accuracy and resilience point of view. For example, a value of a target function may be determined (or estimated based on the validation set), e.g., the value of:

$$ℒ ( {θ}^{opt} ) ≃ {𝔼}_{p ( X )} ( {D}_{sem} ( x , {\hat{x}}_{θ opt} ) + c \cdot {D}_{sem} ( {\hat{x}}_{θ opt} , {\tilde{x}}_{θ opt} ) )$$

This determined or estimated value may be compared to a predetermined threshold. The determined or estimated value varies more than the predetermined threshold, the models may be re-trained with stricter requirements for the optimization quality. This process may be repeated until the targets for the model quality are satisfied.

Referring back to FIG. 4, another procedure that may be performed at the application layers 420 or 460 of the respective transmitter 410 or receiver 450 is motion compensation. On the transmitter 410 side this is shown as motion differentiation 428 and on the receiver 450 side this is shown as motion integration 468. As stated above, the motion compensation may not apply to all data types or data categories. The following provides example details of the motion compensation that may be performed by the motion differentiation 428 of the transmitter 410 or the corresponding motion integration 468 of the receiver 450.

In the latent output space of the semantic processing, it may be considered that there are several consecutive semantic representations of the data inputs, e.g., yₜ₋₂, yₜ₋₁, yₜ. Several parameters related to motion may be defined based on the semantic representations of the data inputs. In a first example, a motion vector (MV) may be defined as a difference between two consecutive representations, e.g., MV(t):=yₜ−yₜ₋₁. In a second example, a motion vector difference (MVD) may be defined as a difference between two consecutive representations: MVD(t):=MV(t)−MV(t−1)=yₜ−2yₜ₋₁+yₜ₋₂.

It may be considered that the communication system may transmit three type of messages for any time moment (t), e.g., yₜ, MV(t) or MVD(t). The yₜ message may be considered as an analog of an “I frame” in standard video transmissions. The MV(t) and MVD(t) messages may be analogized to different kinds of “P frames” in standard video transmissions. As described above, semantic communications are different from standard communications and this analogy is not meant to indicate that the semantic communication messages (yₜ, MV(t) or MVD(t)) are the same as the standard video transmissions. Rather, it is merely meant as a manner of explaining how the motion compensation in semantic communication may be implemented by using the context of a standard video transmission.

At the receiver 450, \tilde{y}, rMV(t) and rMVD(t) are the received semantic representation, received motion vector, and received motion vector difference, respectively. Because the messages were sent using semantic communication methods, the received semantic representations may differ from the semantic representations that were transmitted.

If the receiver 450 has a buffer of size 1 of the received representations, the receiver 450 may determine \tilde{y} from the \tilde{y}ₜ₋₁ and the rMV(t) using the formula:

$${\tilde{y}}_{t} ≃ {\tilde{y}}_{t - 1} + rMV ( t )$$

Similarly, if the receiver 450 has a buffer of size 2 of the received representations, the receiver 450 may determine \tilde{y} from the \tilde{y}ₜ₋₁, \tilde{y}ₜ₋₂ and the rMVD (t) using the formula:

$${\tilde{y}}_{t} ≃ rMVD ( t ) + 2 {\tilde{y}}_{t - 1} - {\tilde{y}}_{t - 2}$$

It may be preferable to transmit motion vector differences instead of the semantic representations since it reduces time-correlation redundancy. However, in the case when approximate received representations are used to obtain the next approximations, the approximation error is accumulating. Compared with the legacy approach (i.e., video codecs), motion vector differences linearly depend on the semantic representations, which makes motion estimation and compensation computationally simple.

To implement the motion compensation, the transmitter 410 and the receiver 450 may agree to a message type pattern. For example, if it were considered that the message types are semantic representations (R), motion vectors (MV), and motion vector differences (MVD), the transmitter 410 and the receiver 450 may agree to a pattern for each data type. An example pattern may be, R R MVD MVD MVD MVD MVD R R . . . . This means the transmitter 410 will transmit sends two consecutive semantic representations, then five consecutive motion vector differences, and then the pattern is repeated.

In some example embodiments, the pattern may be described by triple natural values (A, B, C), where the first value corresponds to the number of consecutive semantic representations (R) in the pattern, the second value corresponds to the number of consecutive motion vectors (MV), and the third value corresponds to the value of consecutive motion vector differences (MVD).

The UE or the network may have a cross-layer mechanism providing the application with the expected rate of the transmission. The application may then select the pattern considering the provided rate expectation.

The procedure of the replacement of the original semantic representations at the transmitter 410 side with MVs or MVDs is termed ‘motion differentiation’ as shown by the motion differentiation 428 in FIG. 4. The procedure of the recovering the original semantic representations by the buffer data and the newly received MV or MVD at the receiver 450 side is termed ‘motion integration’ as shown by the motion integration 468 in FIG. 4.

As described above, in some example embodiments where the communication system is informed about the data category, power scaling is skipped at application layer, and is performed at the MAC and or PHY layers. As also described above, in these example embodiments, the isometric map is used as the semantic processing map, e.g., f:=f^{iso}. In these example embodiments, data statistics that are specific for a particular category may be used to provide to the communication layer performing the power scaling, e.g., to the MAC layer for rate matching/data adaptation procedures and/or to the BB PHY for digital signal processing algorithms. The following provides some examples of the data statistics that may be provided to the MAC or PHY layer.

In a first example, the covariance matrix of the isometrically represented data vectors in the latent space are provided as follows:

$${C}_{m . k} := {𝔼}_{P ( X )} ( {f}_{k} ( x ) \cdot {f}_{m} ( x ) for each k , m = 1 , … , M$$

In a second example, if the motion vectors of the latent representations are to be transmitted, the covariance matrix of the MVs may be provided as follows:

$${C}_{m , k}^{MV} := {𝔼}_{P ( X )} ( ( {f}_{k}^{t} ( x ) - {f}_{k}^{t - 1} ( x ) ) \cdot ( {f}_{m}^{t} ( x ) - {f}_{m}^{t - 1} ( x ) ) for each k , m = 1 , … , M$$

In a third example, if the motion vector differences of the latent representations are to be transmitted, the covariance matrix of the MVDs may be provided as follows:

$${C}_{m , k}^{MVD} := {𝔼}_{P ( X )} ( ( {f}_{k}^{t} ( x ) - 2 {f}_{k}^{t - 1} ( x ) + 2 {f}_{m}^{t - 2} ( x ) ) \cdot ( {f}_{m}^{t} ( x ) - 2 {f}_{m}^{t - 1} ( x ) + 2 {f}_{m}^{t - 2} ( x ) ) for each k , m = 1 , … , M$$

These example matrices may be computed after the model training and then shared between the transmitter 410 and the receiver 450. The matrices may be sparse where small elements may be replaced with zeroes. The sparse matrix format may be used for transmission and storage.

Returning to FIG. 4, the operations of the PHY layers 440 and 480 with respect to semantic communications are described. For the purposes of this description, the PHY channel for semantic communication is termed a Best-Effort (BE) PHY channel. This term is used to distinguish the semantic communication PHY channels from legacy channels. The BE PHY Channels (e.g., BE-Physical Downlink Shared Channel (BE-PDSCH) and BE-Physical Uplink Shard Channel (BE-PUSCH)) are shared (data) channels that exist along with the legacy PDSCH/PUSCH. In some example embodiments, transmission may be scheduled from/to the devices in both the BE channels and the legacy channels in the same time slot.

The BB/RF PHY procedures 448 and 488 for BE-PHY channels may differ from those of legacy PHY channels. For example, modulation and channel coding procedures in the BE PHY channels may use Pseudo-Analog modulation or may not use forward error correction (FEC) channel coding/decoding. In some example embodiments, the BE PHY channels may use QAM, M-PSK or OOK modulations. In other example embodiments, the BE PHY channels may still use a lightweight FEC channel coding/decoding option.

In some example embodiments, the BE PHY channel may support a single user, e.g., superposition of different modulation orders related to the significance of latent features/bits. This is similar to the LTE-A MUST feature but for a single user and for a single stream. For example, QPSK, 16QAM may be used up to the highest possible order QAM, such that the most significant latent features/bits are mapped to QPSK, next relevant latent feature bits (adding some detail) mapped to 16QAM, etc. up to the highest order QAM which will be used for the least significant latent features/bits. A UE close to the cell edge will likely not be able to successfully demodulate higher modulation order(s) whereas a UE close to the cell center will likely be able to successfully demodulate all modulation orders and thus will have the greatest detail for reconstruction. Some coding, e.g., orthogonal cover codes (OCC) may be introduced to enable decoupling/decoding the superimposed latent feature/bit information.

In some example embodiments, the Downlink Control Information (DCI) for a BE data block may contain a modulation scheme index instead of a modulation and coding scheme. A same data block may use multiple modulation schemes within a single transmission. In this case, the DCI indicates all the modulation schemes that are used, and physical resources where each of the modulation schemes is used.

As described above, in some example embodiments, the data category specific semantic models and motion compensations procedures are applied only at the application layer (e.g., application layer 420), the communication layers (e.g., L2 and L3 layers 430 and PHY layer 440) may not be informed about the data category of the transmitted data.

In some example embodiments, a header transmitted via a legacy channel (shared or control channel) may contain a low-layer ID of the transmitted data vector to help the receiver 450 assemble several data vectors transmitted in a overlapping manner. In addition, the header transmitted via legacy channel (shared or control one) may contain an end-of-data vector indication that informs the receiver 450 that no further data of this data vector will be transmitted. When the receiver 450 receives the end-of-data indicator, this indicates to the receiver 450 that it should try to reconstruct a data vector out of the received data.

As described above, the semantic communications may use pseudo-analog modulation. This is not a requirement of semantic communications but one option for modulation. This modulation may be defined as a map: [symbol] ^{m}→C²ⁿ, m, n∈N. In this case, an m-dimensional vector is modulated by n resource elements (e.g., Orthogonal Frequency Division Multiplex (OFDM) subcarriers), which may be demodulated jointly. The modulation/demodulation may be implemented with digital circuits; thus all “real” values are replaced by high-precision bit representations.

In one example, a direct pseudo-analog modulation (1:1 map) may be used as follows:

$${ℝ}^{2} \to ℂ$$

$$( x , y ) \to x + i y$$

In another example, a 1:2 Shannon-Kotelnikov map (Archimedes' spiral) may be used as follows:
[symbol] →

[symbol]

$$x \to ( \frac{Δ}{π} \cdot x \cdot cos ( x ) , i \frac{Δ}{π} \cdot \vert x \vert \cdot sin ( x ) ) ) ,$$

where Δ depends on the signal to interference ratio (SINR) estimation.

In a still further example, a 1:2n Shannon-Kotelnikov map may be used for n>1.

The OFDM waveform may be used in combination with a pre-defined family of pseudo-analog modulations, ordered by the dimension n. In these examples, higher order modulations may be able to modulate a larger value with a lower power at the cost of additional resource consumption.

In further example embodiments, an additional procedure of isometric mapping of the semantic representation vector into the Hamming cube is applied. This may be used to allow the use of traditional modulation schemes (QAM, PSK, OOK, etc.) for semantic communication such as the superposition concept described above. The Hamming cube may be defined as a space of binary sequences of fixed length, equipped with a Hamming distance. Isometric mapping i satisfies the property:

$${‖ y - {y}^{′} ‖}^{2} = {d}_{Ham} ( i ( y ) , i ( {y}^{′} ) )$$

The O(n log n) algorithm is known for Hamming embedding based on random circulant projections.

As also shown in FIG. 4, the PHY layers 440 and 480 may perform whitening 445 and de-whitening 485 operations, respectively. Again, there is no requirement that the whitening 445 and de-whitening 485 operations be applied. The whitening operation 445 may be applied to make the data distribution closer to a normal one, and achieve more balanced power allocation. The whitening operation 445 may be applied to a single data vector that is allocated with the same modulation and isometric (orthonormal) linear transformation and may be applied prior to the actual modulation.

The whitening operation 445 may include centering of the data, application of Hadamard transform, etc. The Hadamard transform is unitary, hence isometric, and has a fast implementation. These transformations are invertible, and the inverse transformation may be performed at the receiver 450, e.g., de-whitening operation 485.

Turning to the L2 and L3 layers 430 and 470 of the transmitter 410 and receiver 450, respectively, the MAC layer may be responsible for resource allocation in the BE-PDSCH and/or BE-PUSCH. For a UE that has a requirement for BE transmission, MAC provides radio resources (in frequency, time, and spatial domains), and a power resource budget.

Thus, at the transmitter 410 side, after semantic processing 425 (and motion differentiation 428 if applied), due to the isometric properties described above, each semantic representation is a vector with properly scaled components. Thus, the value of the vector components may be directly related to the transmission power used for the transmission of this value.

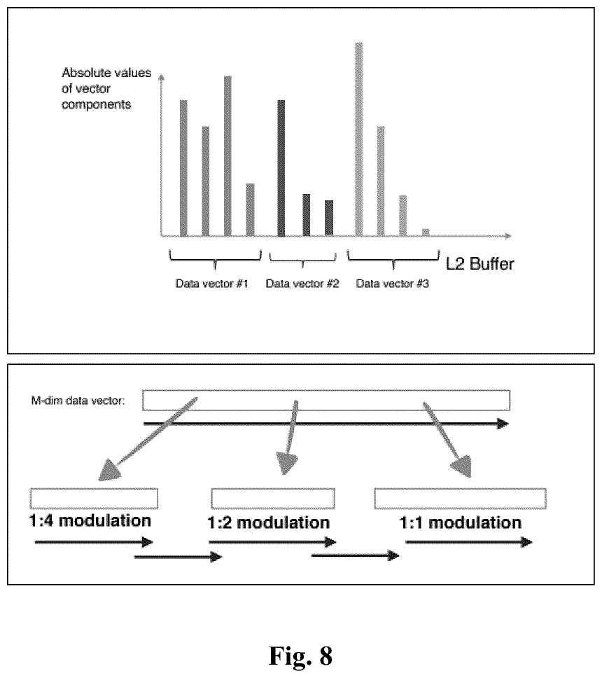

FIG. 8 shows an example of data vectors of semantic representations at a MAC layer of the transmitter 410 according to various example embodiments. The MAC layer may include a local system of IDs for data vectors of the particular UE. With the help of this mechanism, MAC is able to distinguish between the data of different data vectors, e.g., data vector #1, data vector #2 and data vector #3.

Based on the provided power and radio resources, and also considering the hardware (RF) power limitations, the MAC layer may select orders of modulation schemes for the data as shown in FIG. 8, e.g., 1:4 modulation, 1:2 modulation, 1:1 modulation. As shown in FIG. 4, the MAC layer is responsible for SINR estimation and parameter A selection for 1:n modulations with n>1. The use of the parameter A in modulations was described above with reference to the PHY layer. As also shown in FIG. 4, the selected value of this parameter A may be provided to the receiver 450 via control channel DCI.

The data of the particular data vector (e.g., data vector #1) may be mapped onto the radio resources preserving the component order. If data is transmitted using different modulation schemes, the order may be compatible with the highest to lowest modulation scheme ordering.

In some example embodiments, if the MAC layer decides to drop a remaining part of a data vector, the MAC layer of the transmitter 410 may have a protocol opportunity to explicitly inform the receiver 450 about this decision.

The above description provided an overview of the system architecture (FIG. 4) and a general manner of performing semantic communications. The following provides a more detailed example of a specific type of semantic communication termed soft communications. Soft communication is a communication mode for a wireless link that is supposed to deliver data allowing some distortion. Typically, soft communication may be used for numerical data types for data categories, e.g., audio data, video data, etc. There may be other types of semantic communications that are different from soft communications, e.g., subflow communications, programmable protocol semantic communications, etc. The different types of semantic communications are not mutually exclusive and they may be combined in different scenarios and setups.

In the above general example of semantic communications, it was described that the PHY layer implemented a pseudo-analog modulation for semantic communication. In the example of soft communications, the MAC layer may be agnostic to PHY layer modulation, e.g., the example operations of the MAC layer may be used with any type of selected PHY layer modulation. In addition, as will be described in greater detail below, the example MAC layer design for soft communications may allow for both numerical data and metadata (including packet headers) to be transmitted within a single MAC PDU (TB).

As state above, soft communication is typically used for numerical values, e.g., integer or rational data type, which represent a typical output of machine learning or other type of data processing algorithms. The goal of the system is to reduce distortion minimization, e.g., the sum of the distance between the numerical values, as follows:
Σₖ|xₖ−\tilde{x}ₖ|^{p}→min, where x is the original value, \tilde{x} is the received value, and p is a configured system parameter

Based on this approach, latency and distortion requirements may be configured by the system to derive retransmission policy and upper layer handling of the data. The application layer source coding may be designed to make the vector normal distortion of encoded data correspond to the perceptional (semantic) distortion of the original data.

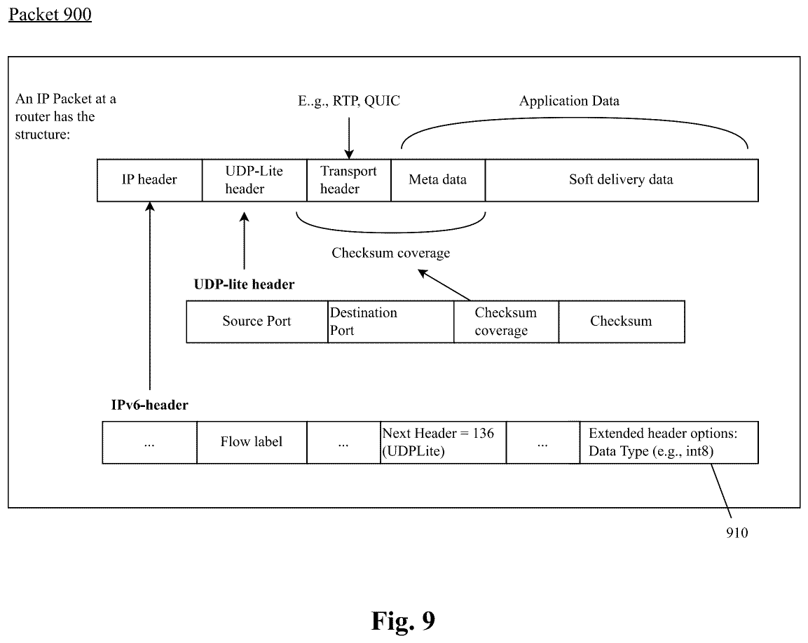

FIG. 9 shows an example Internet Protocol (IP)/transport level protocol packet 900 for soft communications according to various example embodiments. In this example, the Lightweight User Datagram Protocol (UDP-Lite) may be applied for data for soft delivery. The UDP-Lite may be used so a damaged packet will not be discarded by an IP router. The entirety of the data packet 900 is not described because those skilled in the art will understand the purpose of each field and the type of data that may be included in each field.

Rather, this description will focus on the field (e.g., data type field 910) that may be configured for soft communications. The data type field 910 may be configured per packet and may include bit precision and a description of how to interpret the bits, e.g., 8-bit unsigned integer (uint8), 16-bit signed integer (int16), etc.

Other example of data type options to reduce the real-time DCI overhead by providing only an index of the option used, may include a flag indicating an integer or finite field arithmetic Z or Z_{q}, where q is defined by bit precision q:=2^{b}, a distortion power (p), parameters related to a distortion estimation method and a preferred method (e.g., soft checksum method), a threshold for the acceptable distortion, parameters related to a ciphering policy and the preferred method, etc.

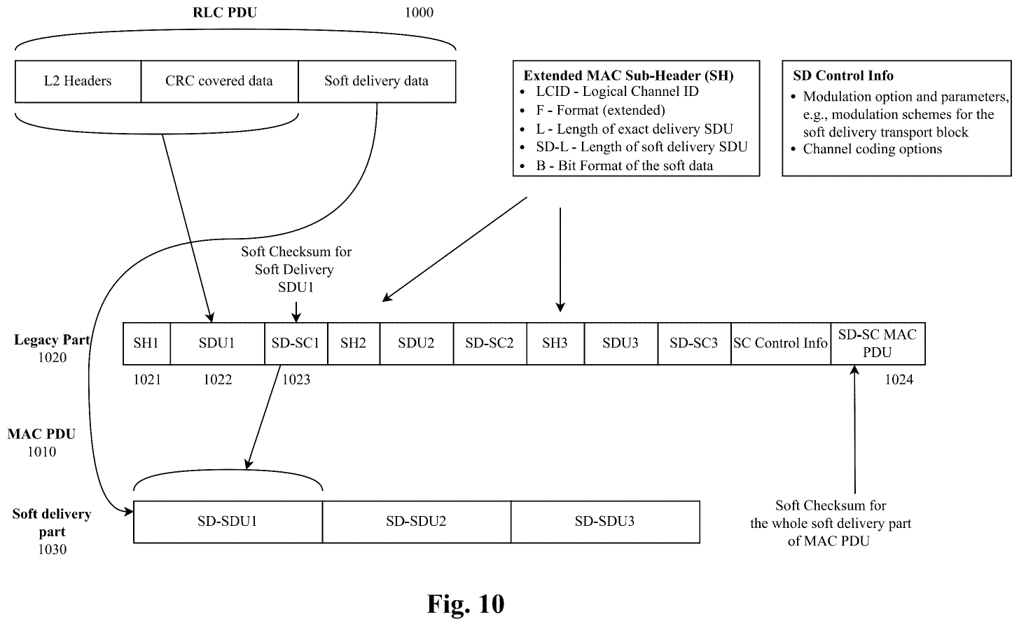

FIG. 10 shows an example of a Radio Link Control (RLC) Protocol Data Unit (PDU) 1000 comprising a MAC PDU 1010 used for soft communications according to various example embodiments. As described above, the semantic communication system may simultaneously schedule a traditional communication (e.g., PDSCH) and a semantic communication (e.g., BE-PDSCH). Thus, the RLC PDU 1000 comprises a legacy part 1020 (or exact part) and a soft delivery part 1030. The MAC layer may be responsible for mapping MAC Service Data Units (SDUs) (or a part of them) into the legacy part 1020 and the soft delivery part 1030 of the RLC PDU 1000. As described in more detail below, for the soft delivery part 1030 of the data, a MAC module may be used to adjust soft PHY parameters and, in some examples, transmit only a part of the allocated soft data.

In the example of FIG. 10, the legacy part 1020 may include consecutive triples of an extended MAC sub-header (e.g., SH1 1021), exactly delivered payload (e.g., SDU1 1022), a soft checksum for soft delivery part (e.g., SD-SC1 1023), followed by soft delivery control information. The extended MAC sub-header may be, for example, a 5G NR MAC sub-header with additional fields indicating the length of accompanying soft delivery SDU part (SD-SDU) and indicating a bit format (related to the data type) of the soft delivery data in this SDU.

The soft checksum for soft delivery SDU may be a value of a function of the corresponding SD-SDU, which is served for soft integrity check purposes and retransmission control policy. There may also be a soft checksum (e.g., SD-SC MAC PDU 1024) for soft delivery of the entire MAC PDU.

In the example embodiments of soft communications, the MAC scheduler provides resource allocation for both the legacy (exact delivery) PDSCH and the soft PDSCH. For example, the MAC scheduler may select the modulation and coding scheme (MCS) for the legacy PDSCH and the multiple input/multiple output (MIMO) rank for both the legacy PDSCH and the soft PDSCH. To accomplish this scheduling, the MAC scheduler may receive a buffer report comprising a data size for the exact communication and a data size for the soft communication. The DCI may be extended accordingly to include two rank indicators and allocation information of the soft part of the transport block (TB).

In addition, the selection of PHY parameters (e.g., modulation, FEC coding, etc.) for soft PDSCH and soft PUSCH may be performed by the MAC entity of the transmitter, e.g., UE MAC for UL and network MAC for the DL.

On the receiver side, the MAC layer may implement various procedures for soft communications in both the downlink (DL) and the uplink (UL). In the DL, the MAC layer may receive the Physical Downlink Control Channel (PDCCH) and decode the DCI to identify the allocation of the legacy PDSCH and the soft PDSCH. The MAC layer may then receive the legacy PDSCH and the soft PDSCH, decode the legacy PDSCH to obtain the location of the soft parts of the data SDUs, if any. The MAC layer may then obtain the soft control information and the soft integrity check value for each soft MAC SDU and soft integrity check for the entire soft PDSCH. The MAC layer may then decode the soft PDSCH that follows the soft control information as was shown above. The MAC layer may then compute the soft integrity check function based on the decoded soft data and compare it with the soft integrity check values delivered in the PDSCH. This may include requesting retransmission if required. The MAC layer may then reconstruct the MAC SDUs from the exact and soft delivery parts and provide them to upper layers.

In the UL, the MAC layer may receive the legacy and soft PUSCH, decode the legacy PUSCH to obtain the location of the soft parts of the data SDUs, if any, the soft control information and the soft integrity check value for each soft MAC SDU and the soft integrity check for the whole soft PUSCH. The MAC layer may then decode the soft PUSCH that follows the soft control information. The MAC layer may then compute the soft integrity check function based on the decoded soft data and compare it with the soft integrity check values delivered in PUSCH, including requesting retransmission, if required. The MAC layer may then reconstruct the MAC SDUs from the exact and soft delivery parts and provide them to upper layers.

Turning to the PHY layer for soft communications, the input to the PHY layer of the transmitter may include data that is organized in the groups of bits G₀, G₁, . . . , G_{B-1}, where G₀ contains the least important bits, G₁ contains the second to last least important bit, etc. For each group of bits, the MAC layer provides the PHY layer with a modulation order Q_{b}, a coding rate R_{b}, and the radio resources to allocate the group.

The PHY layer may also provide an abstraction for the bit error rate (BER) function for soft channel codes. The BER function may be obtained via a link-level simulation and used for PHY abstraction in a system level simulation. BER may be considered as a function of various parameters such as modulation order, effective SINR, codeblock size, coding rate, code type, decoder option, etc. The effective SINR model may be an Exponential Effective SINR Mapping (EESM), where parameters of the averaging are fitted for the coding rate, modulation order, code type, etc. For example, for a fixed code type, decoder option, code block size:
BER: Q_{b}, R_{b}, SNR [symbol] [0, 1]

For the norm, Σₖ|xₖ−\tilde{x}ₖ|^{p}, where xₖ is a value represented as an unsigned int with B bits, the contribution of error in the b-th bit is 2^{p·b}. Thus, the total distortion of the received soft data will be:

$$\frac{1}{K} {\sum }_{k = 1}^{K} {\vert {x}_{k} - {\tilde{x}}_{k} \vert}^{p} ≃ \frac{1}{{\sum }_{b} \vert {G}_{b} \vert} {\sum }_{b} {2}^{p \cdot b} \cdot BER ( {Q}_{b} , {R}_{b} , SNR ) \cdot \vert {G}_{b} \vert ,$$

the index of the communicated value.

Thus, as described above, the input from the MAC scheduler to the PHY layer includes the PHY resource allocation (grant) for both the legacy and soft-delivery parts, the MCS for the legacy part, the MIMO rank for both the legacy and the soft delivery parts. Then, based on this input, RLC PDUs (or parts of RLC PDUs) may be selected for the transmission in the TB.

As also described above, the input from PHY layer includes the SINR estimation for the provided radio resources, a BER model as a function of the form BER: Q_{b}, R_{b}, SNR [symbol] [0,1]. In addition, from the upper layer configuration the PHY layer may receive the distortion norm option, e.g., the exponent (p) as described above and from the RLC PDUs, including bit format information.

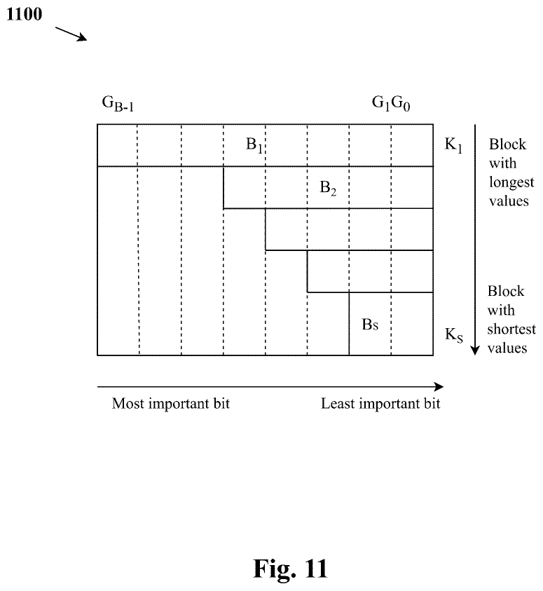

FIG. 11 shows an example soft delivery part 1100 of a transport block (TB) for soft communications according to various example embodiments. As described above, the MAC layer may identify the PHY layer parameters for the soft delivery part such that the soft delivery part of the TB may be constructed according to the following as shown in FIG. 11.

The data may be represented by a set of S blocks (which may correspond to the SD-SDU), where each block (s) is characterized by a specific bit format Bₛ and a number of values Kₛ that it contains. The blocks may be sorted in decreasing order of Bₛ, where B:=max{B₁, . . . , Bₛ} is the maximum bit format.

As described above, groups of bits G₀, G₁, . . . , G_{B-1} are formed, where G₀ contains the least important bit, etc. For each group of bits, G_{b}, the MAC layer may select the QAM modulation scheme Q_{b} and the coding rate R_{b} to minimize the expected distortion, e.g.:

$$\begin{matrix}{\sum }_{b} {2}^{p \cdot b} \cdot BER ( {Q}_{b} , {R}_{b} , SNR ) \cdot \vert {G}_{b} \vert \to min {\{ {Q}_{b} , {R}_{b} \}}_{b = 0}^{B - 1} \\ {\sum }_{b} \frac{{R}_{b} \cdot \vert {G}_{b} \vert}{{log}_{2} {Q}_{b}} \leq {N}_{RE} \cdot {N}_{layers}\end{matrix}$$

The soft delivery control information may include the selected {Q_{b}, R_{b}}_{b=0}^{B-1} that may be transmitted within the legacy part of the TB.

The case of a single MCS being used for all softly transmitted bits within the TB may be a special case for PHY parameter adjustment. Specifically, the system may select bits to transmit and discard the bits. For example, having the knowledge of the data structure (e.g., data type), the MAC is able to select for transmission only the appropriate number of important bits. The soft control information may include the value indicating the number of transmitted bits per each numerical value (bit precision). The receiver may then structure the decoded data according to the soft control information and update the bit format (precision) in the packet data type attribute.

### Examples

In a first example, a method, comprising receiving data inputs corresponding to a plurality of data objects that are to be transmitted by the UE, processing the data inputs to generate a semantic representation of each of the data objects, wherein the semantic representation comprises a semantic distance for each of the data objects, wherein the semantic distance relates each of the data objects to each other and preparing, for transmission, the semantic representations of the data objects.

In a second example, the method of the first example, wherein the semantic distance comprises a geodesic distance or a domain knowledge defined distance.

In a third example, the method of the first example, wherein the data comprises one or more data categories, wherein the semantic distance is defined individually for each data category.

In a fourth example, the method of the third example, wherein the data is processed by a semantic processing machine learning (ML) model, wherein the ML model comprises weights specific to each data category.

In a fifth example, the method of the fourth example, wherein the ML model comprises a diagonal-circulant neural network model.

In a sixth example, the method of the first example, further comprising determining a first motion vector between a first semantic representation of a first data input and a second semantic representation of a second data input, wherein the first and second data inputs are consecutive data inputs.

In a seventh example, the method of the sixth example, further comprising preparing, for transmission, the motion vector rather than the first semantic representation.

In an eighth example, the method of the seventh example, wherein the motion vector is transmitted based on a pattern, wherein the pattern is exchanged between the UE and a further UE to which the UE is transmitting the motion vector.

In a ninth example, the method of the sixth example, further comprising determining a second motion vector between the second semantic representation of the second data input and a third semantic representation of a third data input, wherein the second and third data inputs are consecutive data inputs, determining a motion vector difference between the first semantic representation and the third semantic representation based on the first motion vector and the second motion vector and preparing, for transmission, the motion vector rather than the first semantic representation.

In a tenth example, the method of the ninth example, wherein the motion vector difference is transmitted based on a pattern, wherein the pattern is exchanged between the UE and a further UE to which the UE is transmitting the motion vector difference.

In an eleventh example, the method of the first example, further comprising processing, by a Medium Access Control (MAC) layer or a Physical (PHY) Layer, each of the semantic representations based on a covariance matrix of data vectors related to each of the semantic representations.

In a twelfth example, the method of the eleventh example, wherein the MAC layer processes each of the semantic representations for rate matching or data adaptation.

In a thirteenth example, the method of the first example, wherein the semantic representations are transmitted using a shared channel that is different from a shared channel used by legacy data transmissions.

In a fourteenth example, the method of the first example, further comprising modulating, by a physical (PHY) layer, the semantic representations, wherein the modulation is based on a significance of latent features or bits in each of the semantic representations.

In a fifteenth example, the method of the first example, further comprising determining, by a Medium Access Control (MAC) layer, a modulation to be applied to the semantic representations for transmission, wherein the modulation is determined based on radio resources and a power budget allocated to the semantic representations.

In a sixteenth example, the method of the fifteenth example, further comprising preparing, for transmission to a receiver via Downlink Control Information (DCI), the determined modulation to be applied to the semantic representations.

In a seventeenth example, the method of the first example, further comprising generating, for transmission to a receiver via Downlink Control Information (DCI), an identification of a transmitted semantic representation or an end-of-data vector indicating no additional data will be transmitted for the transmitted semantic representation.

In an eighteenth example, a processor configured to perform any of the methods of the first through seventeenth examples.

In a nineteenth example, a user equipment (UE) configured to perform any of the methods of the first through seventeenth examples.

In a twentieth example, a method, comprising jointly training a variational autoencoder (VAE) and a VAE decoder based on a training data set comprising data related to semantic distance, adding a scaling layer to the VAE to generate a semantic processing model, eliminating noise dimensions from the VAE and training a semantic processing reconstruction model based on the training data set, the semantic processing model and data generated from eliminating the noise dimensions.

In a twenty first example, the method of the twentieth example, further comprising discarding the VAE decoder after joint training.

In a twenty second example, the method of the twentieth example, wherein an optimization target for the joint training of the VAE and VAE decoder is an evidence lower bound.

In a twenty third example, the method of the twentieth example, wherein adding the scaling layer generates an isometric semantic processing model.

In a twenty fourth example, the method of the twentieth example, wherein the processing circuitry eliminates noise dimensions based on comparing an entropy of each noise dimension to an entropy threshold.

In a twenty fifth example, a processor configured to perform any of the methods of the twentieth through twenty fourth examples.

In a twenty sixth example, a user equipment (UE) configured to perform any of the methods of the twentieth through twenty fourth examples.

In a twenty seventh example, a method, comprising receiving a data input corresponding a data object to be transmitted, processing the data input to generate a semantic representation of the data object, generating an Internet Protocol (IP) packet comprising the semantic representation and a header indicating a data type of the semantic representation and generating a transport block (TB) comprising a soft delivery part and an exact delivery part, wherein the soft delivery part comprises the semantic representation of the data object.

In a twenty eighth example, the method of the twenty seventh example, wherein the header further comprises (i) a flag indicating the data object is an integer of a finite field arithmetic, (ii) a distortion power parameter, (iii) parameters related to distortion estimation, (iv) a threshold for acceptable distortion or (v) parameters of a ciphering policy.

In a twenty ninth example, the method of the twenty seventh example, wherein the exact delivery part comprises an extended MAC sub-header, exactly delivered payload, a soft checksum for the soft delivery part and soft delivery control information.

In a thirtieth example, the method of the twenty ninth example, wherein the extended MAC sub-header comprises fields indicating a length of the soft delivery part and a bit format of the semantic representation.

In a thirty first example, the method of the twenty ninth example, wherein the exact delivery part further comprises a triplet of the extended MAC sub-header, exactly delivered payload, the soft checksum for the soft delivery part and soft delivery control information.

In a thirty second example, the method of the thirty first example, wherein the exact delivery part further comprises a soft checksum for the entire TB.

In a thirty third example, the method of the twenty seventh example, further comprising receiving, by a Medium Access Control (MAC) layer, a buffer report comprising a data size for the exact delivery part and the soft delivery part.

In a thirty fourth example, the method of the thirty third example, further comprising determining, by the MAC layer, a resource allocation for the exact delivery part and the soft delivery part based on at least the data size for the exact delivery part and the soft delivery part, selecting, by the MAC layer, a modulation and coding scheme (MCS) for the exact delivery part based on at least the data size for the exact delivery part, selecting, by the MAC layer, a multiple input/multiple output (MIMO) rank for each of the exact delivery part and the soft delivery part based on at least the data size for the exact delivery part and the soft delivery part.

In a thirty fifth example, the method of the thirty third example, further comprising determining, by the MAC layer, a selection of physical (PHY) layer parameters for transmitting the soft delivery part.

In a thirty sixth example, the method of the thirty fifth example, wherein the PHY layer parameters comprise a modulation or a forward error correction (FEC) coding.

In a thirty seventh example, the method of the thirty fourth example, further comprising configuring Downlink Control Information (DCI) comprising a MIMO rank indicator for each of the exact delivery part and the soft deliver part and allocation information for the soft delivery part.

In a thirty eighth example, a processor configured to perform any of the methods of the twenty seventh through thirty seventh examples.

In a thirty ninth example, a user equipment (UE) configured to perform any of the methods of the twenty seventh through thirty seventh examples.

Those skilled in the art will understand that the above-described example embodiments may be implemented in any suitable software or hardware configuration or combination thereof. An example hardware platform for implementing the example embodiments may include, for example, an Intel x86 based platform with compatible operating system, a Windows OS, a Mac platform and MAC OS, a mobile device having an operating system such as iOS, Android, etc. The example embodiments described above may be embodied as a program containing lines of code stored on a non-transitory computer readable storage medium that, when compiled, may be executed on a processor or microprocessor.

In some embodiments, a non-transitory computer-readable memory medium (e.g., a non-transitory memory element) may be configured so that it stores program instructions and/or data, where the program instructions, if executed by a computer system, cause the computer system to perform a method, e.g., any of a method embodiments described herein, or, any combination of the method embodiments described herein, or, any subset of any of the method embodiments described herein, or, any combination of such subsets.

In some embodiments, a device (e.g., a UE) may be configured to include a processor (or a set of processors) and a memory medium (or memory element), where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device may be realized in any of various forms.

Embodiments of the present invention may be realized in any of various forms. For example, in some embodiments, the present invention may be realized as a computer-implemented method, a computer-readable memory medium, or a computer system. In other embodiments, the present invention may be realized using one or more custom-designed hardware devices such as ASICs. In other embodiments, the present invention may be realized using one or more programmable hardware elements such as FPGAs.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

As described above, one aspect of the present technology is the gathering and use of data available from specific and legitimate sources to improve the delivery to users of invitational content or any other content that may be of interest to them. The present disclosure contemplates that in some instances, this gathered data may include personal information data that uniquely identifies or can be used to identify a specific person. Such personal information data can include demographic data, location-based data, online identifiers, telephone numbers, email addresses, home addresses, data or records relating to a user's health or level of fitness (e.g., vital signs measurements, medication information, exercise information), date of birth, or any other personal information.

The present disclosure recognizes that the use of such personal information data, in the present technology, can be used to the benefit of users. For example, the personal information data can be used to deliver targeted content that may be of greater interest to the user in accordance with their preferences. Accordingly, use of such personal information data enables users to have greater control of the delivered content.

The present disclosure contemplates that those entities responsible for the collection, analysis, disclosure, transfer, storage, or other use of such personal information data will comply with well-established privacy policies and/or privacy practices. In particular, such entities would be expected to implement and consistently apply privacy practices that are generally recognized as meeting or exceeding industry or governmental requirements for maintaining the privacy of users. Such information regarding the use of personal data should be prominent and easily accessible by users, and should be updated as the collection and/or use of data changes. Personal information from users should be collected for legitimate uses only. Further, such collection/sharing should occur only after receiving the consent of the users or other legitimate basis specified in applicable law. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations that may serve to impose a higher standard. For instance, in the US, collection of or access to certain health data may be governed by federal and/or state laws, such as the Health Insurance Portability and Accountability Act (HIPAA); whereas health data in other countries may be subject to other regulations and policies and should be handled accordingly.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, such as in the case of advertisement delivery services, the present technology can be configured to allow users to select to “opt in” or “opt out” of participation in the collection of personal information data during registration for services or anytime thereafter. In another example, users can select not to provide mood-associated data for targeted content delivery services. In yet another example, users can select to limit the length of time mood-associated data is maintained or entirely block the development of a baseline mood profile. In addition to providing “opt in” and “opt out” options, the present disclosure contemplates providing notifications relating to the access or use of personal information. For instance, a user may be notified upon downloading an app that their personal information data will be accessed and then reminded again just before personal information data is accessed by the app.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing identifiers, controlling the amount or specificity of data stored (e.g., collecting location data at city level rather than at an address level), controlling how data is stored (e.g., aggregating data across users), and/or other methods such as differential privacy.

Therefore, although the present disclosure broadly covers use of personal information data to implement one or more various disclosed embodiments, the present disclosure also contemplates that the various embodiments can also be implemented without the need for accessing such personal information data. That is, the various embodiments of the present technology are not rendered inoperable due to the lack of all or a portion of such personal information data. For example, content can be selected and delivered to users based on aggregated non-personal information data or a bare minimum amount of personal information, such as the content being handled only on the user's device or other non-personal information available to the content delivery services.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

1. An apparatus comprising processing circuitry configured to:
receive data inputs corresponding to a plurality of data objects that are to be transmitted;
process the data inputs to generate a semantic representation of each of the data objects, wherein the semantic representation comprises a semantic distance for each of the data objects, wherein the semantic distance relates each of the data objects to each other; and
prepare, for transmission, the semantic representations of the data objects.

2. The apparatus of claim 1, wherein the semantic distance comprises a geodesic distance or a domain knowledge defined distance.

3. The apparatus of claim 1, wherein the data comprises one or more data categories, wherein the semantic distance is defined individually for each data category.

4. The apparatus of claim 3, wherein the data is processed by a semantic processing machine learning (ML) model, wherein the ML model comprises weights specific to each data category.

5. The apparatus of claim 1, wherein the processing circuitry is further configured to:
determine a first motion vector between a first semantic representation of a first data input and a second semantic representation of a second data input, wherein the first and second data inputs are consecutive data inputs.

6. The apparatus of claim 5, wherein the processing circuitry is further configured to:
prepare, for transmission, the motion vector rather than the first semantic representation.

7. The apparatus of claim 5, wherein the processing circuitry is further configured to:
determine a second motion vector between the second semantic representation of the second data input and a third semantic representation of a third data input, wherein the second and third data inputs are consecutive data inputs;
determine a motion vector difference between the first semantic representation and the third semantic representation based on the first motion vector and the second motion vector; and
prepare, for transmission, the motion vector rather than the first semantic representation.

8. The apparatus of claim 1, wherein the processing circuitry is further configured to:
process, by a Medium Access Control (MAC) layer or a Physical (PHY) Layer, each of the semantic representations based on a covariance matrix of data vectors related to each of the semantic representations.

9. The apparatus of claim 1, wherein the processing circuitry is further configured to:
modulate, by a physical (PHY) layer, the semantic representations, wherein the modulation is based on a significance of latent features or bits in each of the semantic representations.

10. The apparatus of claim 1, wherein the processing circuitry is further configured to:
determine, by a Medium Access Control (MAC) layer, a modulation to be applied to the semantic representations for transmission, wherein the modulation is determined based on radio resources and a power budget allocated to the semantic representations.

11. The apparatus of claim 1, wherein the processing circuitry is further configured to:
generate, for transmission to a receiver via Downlink Control Information (DCI), an identification of a transmitted semantic representation or an end-of-data vector indicating no additional data will be transmitted for the transmitted semantic representation.

12. An apparatus comprising processing circuitry configured to:
jointly train a variational autoencoder (VAE) and a VAE decoder based on a training data set comprising data related to semantic distance;
add a scaling layer to the VAE to generate a semantic processing model;
eliminate noise dimensions from the VAE; and
train a semantic processing reconstruction model based on the training data set, the semantic processing model and data generated from eliminating the noise dimensions.

13. The apparatus of claim 12, wherein the processing circuitry is further configured to:
discard the VAE decoder after joint training.

14. The apparatus of claim 12, wherein adding the scaling layer generates an isometric semantic processing model.

15. The apparatus of claim 12, wherein the processing circuitry eliminates noise dimensions based on comparing an entropy of each noise dimension to an entropy threshold.

16. An apparatus comprising processing circuitry configured to:
receive a data input corresponding a data object to be transmitted;
process the data input to generate a semantic representation of the data object;
generate an Internet Protocol (IP) packet comprising the semantic representation and a header indicating a data type of the semantic representation; and
generate a transport block (TB) comprising a soft delivery part and an exact delivery part, wherein the soft delivery part comprises the semantic representation of the data object.

17. The apparatus of claim 16, wherein the header further comprises (i) a flag indicating the data object is an integer of a finite field arithmetic, (ii) a distortion power parameter, (iii) parameters related to distortion estimation, (iv) a threshold for acceptable distortion or (v) parameters of a ciphering policy.

18. The apparatus of claim 16, wherein the exact delivery part comprises an extended MAC sub-header, exactly delivered payload, a soft checksum for the soft delivery part and soft delivery control information.

19. The apparatus of claim 18, wherein the extended MAC sub-header comprises fields indicating a length of the soft delivery part and a bit format of the semantic representation.

20. The apparatus of claim 18, wherein the exact delivery part further comprises a triplet of the extended MAC sub-header, exactly delivered payload, the soft checksum for the soft delivery part and soft delivery control information.
